(19) United States
(12) Patent Application Publication
(10) Pub. No.: US 2005/0226342 A1
(43) Pub. Date: Oct. 13, 2005

(54) System and method for mapping information symbols to transmission symbols

(76) Inventors: Fady Alajaji, Kingston (CA); Glen Takahara, Kingston (CA); Norman C. Beaulieu, Edmonton (CA)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 11/070,879

(22) Filed: Mar. 3, 2005

Related U.S. Application Data
(60) Provisional application No. 60/549,150, filed on Mar. 3, 2004.

(51) Int. Cl. H04L 5/12

(52) U.S. Cl. 375/264

(57) ABSTRACT

Systems and methods for performing mapping from information symbols to transmission symbols and corresponding de-mapping operations mapping are provided which employ one of a plurality of mappings for a given signal constellation on the basis of information determined from an analysis of the information symbols. For example, different mappings may be employed for various ranges of non-uniformity, entropy, redundancy, memory in the information symbols.

### CROSS-REFERENCE TO RELATED APPLICATION

This application claims the benefit of prior U.S. provisional patent application No. 60/549,150 filed Mar. 3, 2004.

### FIELD OF THE INVENTION

The invention relates to systems and methods for mapping information symbols to transmission symbols such as modulation symbols.

### BACKGROUND OF THE INVENTION

An information stream containing a sequence of bits which contains about the same number of “ones” and “zeros” is said to have a uniform distribution. For a uniformly distributed information stream, the Gray mapping in two dimensional signaling is widely known as optimal for minimizing bit error rate. However, many data sources, such as image or speech signals to name a few examples, are non-uniformly distributed. A non-uniformly distributed information stream contains a substantial amount of natural redundancy. Even when such information streams are compressed, they still exhibit a residual redundancy due to the suboptimality of the compression scheme. This redundancy, inherent or residual (after source coding) has two forms: redundancy due to the nonuniform distribution of the source symbols and redundancy due to source memory. The redundancy due to the source nonuniformity can be statistically characterized by modeling the source (before or after compression) as an independent identically distributed nonuniform process. The total redundancy (due to both nonuniformity and memory) can be described using a Markov process model.

Referring now to FIG. 1, shown is a block diagram of a mapping system typically implemented in a conventional modem. Shown is an input stream 10, which might be a stream of bits for example, which is processed by processing function 12. The processing function 12 typically implements some combination of interleaving, channel coding etc. to produce a mapper input stream 14 which is fed to static mapper 16. The static mapper 16 takes the bits in the mapper input stream 14 and maps them to modulation symbols 18 using a static mapping. The mapping is static in the sense that the same permutation of adjacent bits will always be mapped to the same modulation symbols. The so called Gray mapping has been the most popular and is considered optimal for a uniformly distributed mapper input stream 14, at least at high signal-to-noise ratios. Having said that, a given conventional transmitter may be capable of implementing multiple mapping functions. However, there is only one mapping function for a given signal constellation. Thus, a first mapping might be used for a binary signal constellation, a second mapping used for quaternary signaling constellation, and a third mapping used for 8-ary constellation for example. It is common for existing modem designs to adaptively switch between signal constellations, and by extension the associated mappings, typically as a function of channel quality.

### SUMMARY OF THE INVENTION

According to one broad aspect, the invention provides a method comprising: determining mapping selection information in respect of a set of information symbols; selecting a selected mapping from a plurality of mappings for a signal constellation as a function of the mapping selection information; mapping the set of information symbols to the signal constellation using the selected mapping to produce transmission symbols.

In some embodiments, the transmission symbols comprise modulation symbols.

In some embodiments, the method further comprises: dividing an information symbol stream into a plurality of sets of information symbols; performing the steps of determining, selecting and mapping for each set of said plurality of sets.

In some embodiments, the method further comprises: for each set of information symbols, transmitting mapping information allowing an identification of the selected mapping for the set of information symbols.

In some embodiments, the mapping information comprises an identifier for the selected mapping.

In some embodiments, determining mapping selection information comprises determining a measure of entropy in respect of the set of information symbols.

In some embodiments, determining mapping selection information comprises determining a measure of non-uniformity within the set of information symbols.

In some embodiments, the method further comprises transmitting non-uniformity information in respect of the set of information symbols from which the selected mapping can be derived.

In some embodiments, the information symbols comprise bits, and wherein the measure of non-uniformity is determined by determining how many bits in the set of information symbols are ones and how many bits in the set of information symbols are zeros.

In some embodiments, determining mapping selection information comprises determining a measure of memory in the set of information symbols.

In some embodiments, determining mapping selection information comprises determining a measure of memory and non-uniformity a set of information symbols.

In some embodiments, the method further comprises transmitting the transmission symbols.

In some embodiments, the transmission symbols comprise carrierless transmission symbols.

In some embodiments, the method further comprises transmitting the modulation symbols.

In some embodiments, transmitting the modulation symbols comprises transmitting the modulation symbols on a wireless channel.

In some embodiments, one of said plurality of mappings is a Gray mapping, and at least one of the plurality of mappings is an Mₙ mapping.

In some embodiments, said plurality of mappings comprises a first mapping which is a Gray mapping, a second mapping which is an Mₙ mapping, and a third mapping which is an inverse of the Mₙ mapping.

In some embodiments, the first mapping is employed for a first range of non-uniformity in the set of information symbols, the second mapping is employed for a second range of non-uniformity in the set of information symbols, and the third mapping is employed for a third range of non-uniformity in the set of information symbols.

In some embodiments, each of said plurality of mappings provides enhanced BER (bit error rate) performance over a communications channel of interest for a respective range of measure of entropy.

In some embodiments, the plurality of mappings comprise a respective mapping for each of a plurality of ranges of non-uniformity.

In some embodiments, the method further comprises: remotely receiving the transmission symbols; processing the transmission symbols using knowledge of the selected mapping.

In some embodiments, the transmission symbols comprise modulation symbols.

In some embodiments, the modulation symbols are processed using a MAP (maximum a posteriori) detector.

In some embodiments, the method further comprises determining the selected mapping using blind detection.

In some embodiments, the method further comprises: remotely receiving the transmission symbols; remotely receiving the mapping information; determining the selected mapping from the mapping information; processing the transmission symbols using the selected mapping.

In some embodiments, the mapping information identifies the selected mapping, the method further comprising: inferring a signal non-uniformity from the mapping information; performing MAP detection using the signal non-uniformity.

In some embodiments, the mapping information identifies a signal non-uniformity, the method further comprising: remotely determining the selected mapping from the signal non-uniformity; performing MAP detection using the signal non-uniformity.

In some embodiments, a modem is provided which is adapted to implement a method as summarized above.

In some embodiments, a transmitter is provided which is adapted to implement a method as summarized above.

In some embodiments, a computer readable medium is provided having instructions stored thereon for execution on a processing platform so as to implement a method as summarized above.

According to another broad aspect, the invention provides a mapping system for mapping a set of information symbols to a transmission symbols of a signal constellation, the mapping system comprising: a mapper input stream analyzer adapted to analyze the set of information symbols and determine a selected mapping from a plurality of mappings for the signal constellation; a mapper adapted to map the set of information symbols to the signal constellation using the selected mapping to produce transmission symbols.

Another embodiment provides a modem comprising the above summarized mapping system.

Another embodiment provides a transmitter comprising the above summarized mapping system, the transmitter being adapted to transmit the transmission symbols.

In some embodiments, the mapping system is further adapted to divide an information symbol stream into a plurality of sets of information symbols; wherein the mapper input stream analyzer and the mapper analyze each set and select a mapping for each set.

In some embodiments, the mapping system is further adapted to, for each set of information symbols, transmit mapping information allowing an identification of the selected mapping for the set of information symbols.

In some embodiments, the mapper determines at least one of symbol non-uniformity, entropy, redundancy, memory in determining the selected mapping.

According to another broad aspect, the invention provides a de-mapper comprising: an input for receiving a set of transmission symbols which were mapped from a set of information symbols using a selected mapping of a plurality of mappings for a signal constellation; a transmission symbol processor adapted to process the transmission symbols using knowledge of the selected mapping.

In some embodiments, the de-mapper is adapted to obtain knowledge of the selected mapping using blind detection.

In some embodiments, the de-mapper is further adapted to receive mapping information allowing an identification of the selected mapping.

In some embodiments, the mapping information identifies the selected mapping, the de-mapper being further adapted to infer a signal non-uniformity from the mapping information, and to perform MAP detection using the signal non-uniformity.

In some embodiments, the mapping information identifies a signal non-uniformity, the de-mapper being further adapted to determine the selected mapping from the signal non-uniformity, and perform MAP detection using the signal non-uniformity.

According to another broad aspect, the invention provides a system comprising a transmitter and a receiver, the transmitter comprising: a mapping system for mapping a set of information symbols to a transmission symbols of a signal constellation, the mapping system comprising: a mapper input stream analyzer adapted to analyze the set of information symbols and determine a selected mapping from a plurality of mappings for the signal constellation; a mapper adapted to map the set of information symbols to the signal constellation using the selected mapping to produce transmission symbols for transmission by the transmitter; the receiver comprising: an input for receiving a set of transmission symbols which were mapped from a set of information symbols using a selected mapping of a plurality of mappings for a signal constellation; and a transmission symbol processor adapted to process the transmission symbols using knowledge of the selected mapping.

In some embodiments, the transmitter is further adapted to: divide an information symbol stream into a plurality of sets of information symbols, and to analyze each set and select a mapping for each set; for each set of information symbols, transmit mapping information allowing an identification of the selected mapping for the set of information symbols; wherein the receiver is adapted to receive the mapping information allowing an identification of the selected mapping for each set of information symbols.

### BRIEF DESCRIPTION OF THE DRAWINGS

Preferred embodiments of the invention will now be described with reference to the attached drawings in which:

FIG. 1 is a block diagram of a mapping system typically implemented in a conventional modem;

FIG. 2A is a block diagram of a mapping system provided by an embodiment of the invention;

FIG. 2B is a high level block diagram of how a signal generated by the mapping system of FIG. 2A would be processed;

FIG. 3 is a block diagram of another mapping system provided by an embodiment of the invention;

FIG. 4 is a block diagram of another mapping system provided by an embodiment of the invention;

FIG. 5 is a plot of bit error rate performance for three different mappings and various values of q;

FIGS. 6A through 6J are plots of signal uniformity for various files using a block size of 3000;

FIG. 7A is a plot of the bit error rate performance of various mappings for a file having the signal uniformity plotted in FIG. 6F;

FIG. 7B is a plot of bit error rate performance for various mappings for a file having the signal uniformity plotted in FIG. 6B;

FIG. 7C is a plot of bit error rate performance for various mappings for a file having the signal non-uniformity plotted in FIG. 6G;

FIG. 8A is a plot of the performance of a Gray mapping for the file having the signal uniformity plotted in FIG. 6B above, and the performance using an adaptive mapping provided by the embodiment of the invention;

FIG. 8B is a plot of the performance of various mappings including an adaptive mapping provided by an embodiment of the invention for a document having the signal non-uniformity plotted in FIG. 6B;

FIG. 8C is a plot of the performance of various mappings including an adaptive mapping provided by an embodiment of the invention for a document having the signal non-uniformity plotted in FIG. 6F;

FIG. 9 is an example of an M₁ mapping for 64 QAM;

FIGS. 10A through 10E are plots of signal uniformity for examples corresponding to FIG. 6G for block sizes of 600 to 16800 over which non-uniformity is measured;

FIGS. 11A through 11E are plots of signal uniformity for examples corresponding to FIG. 6F for block sizes of 600 to 16800 over which non-uniformity is measured;

FIG. 12 is a plot of performance examples for a Rayleigh fading channel; and

FIG. 13 is a plot of performance examples for a MIMO (multiple input multiple output) system.

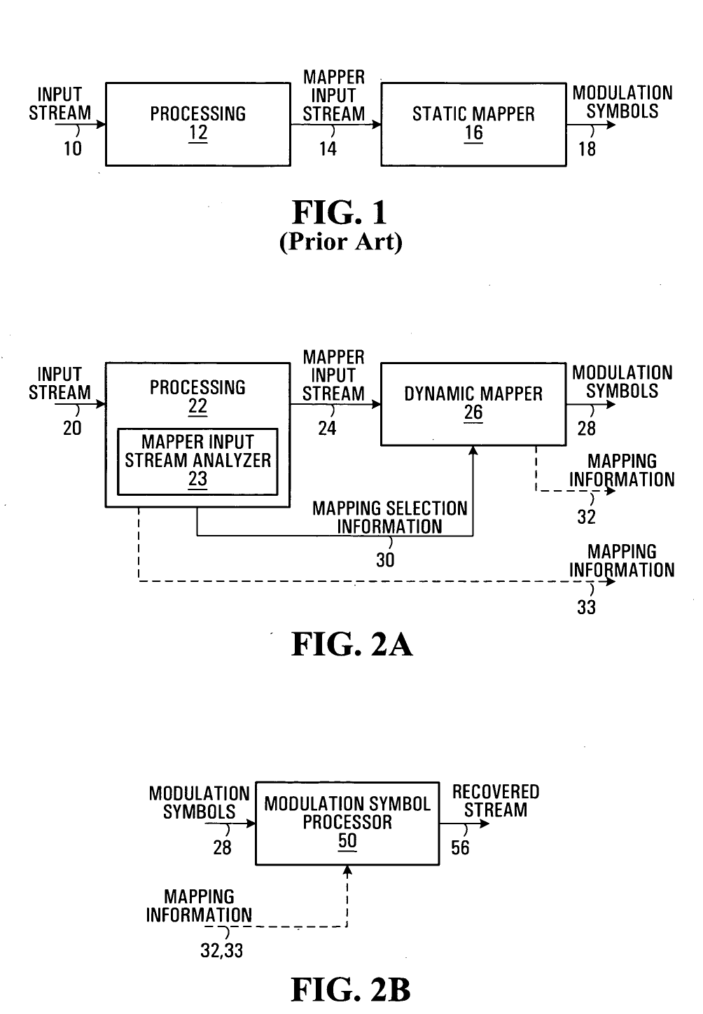

### DETAILED DESCRIPTION OF THE PREFERRED EMBODIMENTS

Referring now to FIG. 2A, shown is a block diagram of a mapping system provided by an embodiment of the invention. The system has a processing function 22 containing a mapper input stream analyzer 23. The processing function 22 receives input stream 20 and produces mapper input stream 24 and mapping selection information 30. The mapper input stream 24 and the mapping selection information 30 are input to a dynamic mapper 26 which produces modulation symbols at output 28. In some embodiments, the dynamic mapper 26 also outputs mapping information 32. In other embodiments, the processing function 22 outputs mapping information 33.

The processing function 22 may be implemented as any one or a combination of hardware, software, and firmware. Similarly, the dynamic mapper 26 may be implemented as any one or a combination of hardware, software and firmware. While the two functions for processing 22 and mapping 26 are shown as two distinct elements in the illustrated embodiment, more generally any number of one or more elements may be used to implement the combination. For example, they could be implemented in a single chip, or with a single program. Depending on the number of elements used to implement the functionality, the signalling between the various elements may differ from that specifically illustrated in FIG. 2A.

The functionality of FIG. 2A may be implemented as part of any system responsible for generating modulation symbols 28 from an input stream 20. For example, the functionality might be included in a modem, a transmitter such as a wireless transmitter, or a modem within a transmitter to name a few examples. In a wireless transmitter, the modulation symbols 28 would be transmitted over a wireless channel. The functionality might be implemented in a data transmission component or system, or in a data storage component or system.

In operation, the processing function 22 processes the input stream 20 using whatever conventional processing is required. This might be some combination of channel encoding, interleaving etc. The processing function 22 produces the mapper input stream 24. In some embodiments, there is no processing to perform, and in such cases the mapper input stream 24 is the same as input stream 20. The mapper input stream analyzer 23 processes the mapper input stream 24 to determine the mapping selection information 30.

The dynamic mapper 26 then performs a mapping of the mapper input stream 24 to modulation symbols of a signal constellation to produce the modulation symbols 28 using a mapping selected from a plurality of mappings as a function of the mapping selection information 30. The number of information symbols, e.g. bits, mapped to a modulation symbol is well known to be a function of the size of the signal constellation. K bits can be mapped to a signal constellation having at least 2^{K} points. The mapping information 32 or 33 is information which can be made available to a receiver of the modulation symbols 28 (more generally any device responsible for processing the modulation symbols 28) to allow the receiver to know which mapping was employed by the dynamic mapper 26. This mapping information 32,33 when present may be transmitted in any suitable channel. For example, a parallel control channel may be used. Alternatively the information may be included in a single signal which also carries the modulation symbols 28.

In some embodiments, a respective mapping is used by the dynamic mapper 26 for each set of N bits of the mapper input stream. If K bits are mapped per symbol, then N/K modulation symbols are produced between each update of the selected mapping. N is a system parameter. A very large N will increase the likelihood that the N bits are substantially uniformly distributed, and will cause the dynamic mapper 26 to behave basically the same as a static mapper. On the other hand, a smaller N may increase the amount of overhead in systems in which mapping information 32 and/or 33 is transmitted. More generally, the respective mapping may be used for a respective set of bits, with the sets of bits not necessarily being equal in size. As a specific example, sets of N=100 bits might be mapped to a 16 QAM (quadrature amplitude modulation) constellation using one of three mappings, with four bits being mapped to each modulation symbol, and 25 modulation symbols being produced per set of 100 bits. One way to identify which of the three mappings was used is to transmit two bits set to indicate the specific mapping employed. This represents an overhead of two bits per 100 bits being mapped.

A large file which is more or less uniformly distributed may contain local non-uniformities. Because of this, an adaptive mapping may still outperform a Gray mapping if N is selected small enough to capture these non-uniformities.

The mapper input stream analyzer 23 is any functionality which processes the mapper input stream to determine mapper selection information 30. In one embodiment, the mapper input stream analyzer 23 determines a non-uniformity metric in respect of the mapper input stream 24 for each set of N bits. This non-uniformity metric might for example be some measure of an imbalance between the frequency of zeros and ones in the mapper input stream. For example, it might be a number of zeros and a number of ones, or a percentage of zeros vs. ones.

The mapping selection information 30 consists of information which enables the dynamic mapping 26 to select an appropriate mapping for each set of N bits of the mapper input stream 24. It is important to note that the mapping selection information 30 operates within a given signal constellation to allow the selection of one of a plurality of possible mappings for the signal constellation. For a different signal constellation, the mapping selection information 30 operates within that signal constellation to select from a different plurality of possible mappings for the different signal constellation.

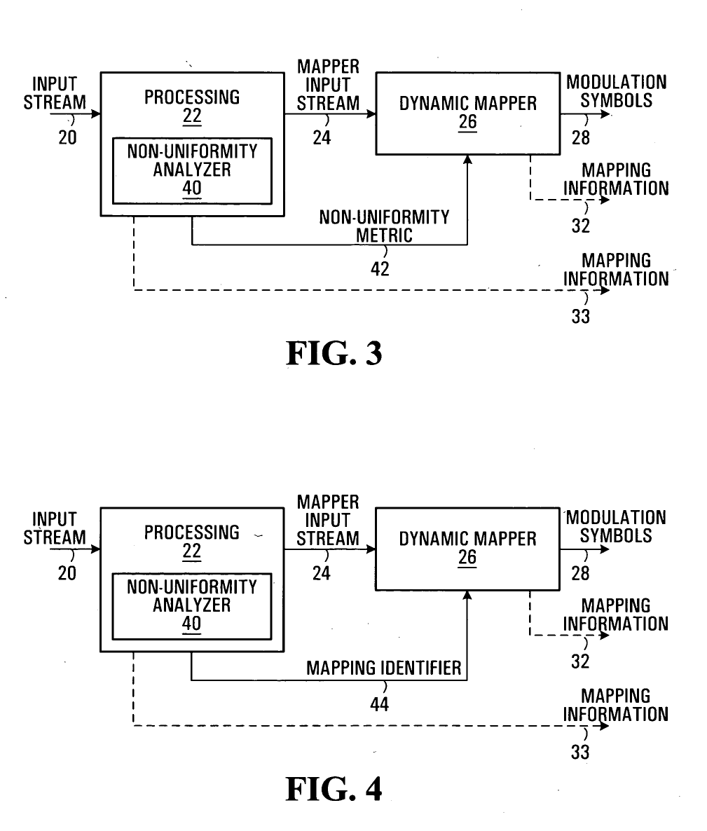

In the embodiment of FIG. 3, the mapper input stream analyzer is implemented with a non-uniformity analyzer function 40. In the embodiment shown in FIG. 3, the non-uniformity metric 42 is output as mapping selection information directly which is then used by the dynamic mapper 26 to select a mapping. In another embodiment, shown in FIG. 4, the non-uniformity metric is used by the non-uniformity analyzer 40 to select an appropriate mapping in which case the mapping selection information is a mapping identifier 44 identifying the selected mapping.

Any number of mappings may be employed in a given implementation. In one particular example, three mappings are employed. One of these is the Gray mapping; one is the so-called M₁ mapping detailed below, and the other is an inversion of the M₁ mapping, hereafter referred to as the M₁′ mapping. In another embodiment, one or more mappings is an Mₙ mapping as described below. One mapping may be a Gray mapping. One or more mappings may be an Mₙ′ mapping, an Mₙ′ mapping being the inverse of the Mₙ mapping, created by inverting all the bits of the Mₙ mapping.

In another embodiment, the mapper input stream analyzer 23 determines a measure of entropy in the mapper input stream, and this measure of entropy is used as a basis for performing mapping selection.

In another embodiment, the mapper input stream analyzer 23 determines a measure of redundancy in the mapper input stream, and this measure of redundancy is used as a basis for performing mapping selection. Redundancy can include both non-uniformity and memory effects. In a preferred embodiment, the dynamic mapper 26 implements a discrete set of static mapping functions, with one mapping being executed for a respective range of a metric being measured by the mapper input stream analyzer 23. In some embodiments the dynamic mapper 26 has all of the mappings implemented in hardware. In another embodiment, the dynamic mapper 26 has the mappings stored in memory for recall as required. In some embodiments, the mapping selection information is only used when a change in the mapping is required. In this case, the previously selected mapping is employed until a new mapping is selected. In other embodiments, the mapping selection information is processed for every set of N bits.

Mapping information 32/33 is any information that will allow a de-mapper to select the proper mapping. This can be an identification of the mapping per se, or an identification of other information allowing a mapping to be selected. For example, if the mapping is selected on the basis of signal non-uniformity, sending information concerning the signal non-uniformity would also allow a receiver to determine the mapping used. In one implementation, several bits are transmitted each time the mapping changes so as to identify the next mapping. These can be sent on a separate channel from the modulation symbols, or embedded within a transmitted signal containing the modulation symbols.

Referring now to FIG. 2B shown is a block diagram of a de-mapper provided by an embodiment of the invention. The de-mapper comprises modulation symbol processor 50 which processes the modulation symbols 28 output by the dynamic mapper of FIG. 2A possibly after the modulation symbols were transmitted over a channel, the channel introducing channel impairments which may alter the symbols. In embodiments in which mapping information 32/33 was output in respect of the modulation symbols 28, this information is used by the modulation symbol processor 50.

Once the mapping used at the source is known, any method of processing the received modulation symbols may be employed. For example, any existing method of processing received modulation symbols mapped using a static mapper may be employed so long as the mapping is changed as required to reflect the mapping performed. This processing may involve some combination of steps such as symbol detection, de-mapping, decoding, for example all of which are well understood by those skilled in the art. For example, MAP detection or ML (maximum likelihood) decoding or approximations thereof might be implemented in a receiver.

The functionality of FIG. 2B may be implemented in any system requiring the conversion of a modulation symbol stream produced using the dynamic mapper 26 of FIG. 2A back to an information stream. This might be implemented in a modem, a receiver such as a wireless receiver, or a modem within a receiver to name a few examples. In a receiver implementation, the modulation symbols 28 are received as an input. The functionality might be implemented in a data reception component or system, or in a data storage component or system.

In some embodiments, a transmitter of modulation symbols generated using the dynamic mapping provided by embodiments of the invention does not send any mapping information to assist a receiver of the modulation symbols in selecting an appropriate mapping. For the example of FIG. 2A, in such an embodiment no mapping information 32/33 is output. For such an embodiment, the receiver performs a blind detection function. This may for example involve performing the demapping/demapping and decoding operations for each possible mapping, and analyzing the results for example using error rate assessment or other schemes to determine which one was correct. This can be done by performing channel decoding, or parity analysis for example. This may be application specific and may depend upon additional knowledge about the information being transmitted.

As indicated above, in some embodiments, MAP detection is used to recover the information from the modulation symbols. MAP detection requires an estimate of noise power. There are many methods known to one skilled in the art of generating an estimate of the noise power, and any of these may be employed, or new methods alternatively may be developed. MAP detection also requires information about the probabilities of each information symbol in the information stream. For example, for binary information, MAP detection needs to know the relative probability of a bit being a one or a zero. In one embodiment, the mapping information 32/33 identifies which mapping was employed to generate the modulation symbols, and the mapping information is used to infer information on the relative probabilities of the information symbols.

For example, consider an implementation in which “q” is the probability of a “zero”, 1-q being the probability of a “one”, and in which the following mappings are used:
0<q<0.4: a first mapping is used;
0.4<q<0.65: a second mapping is used;
0.65<q<1.0: a third mapping is used.
   The mapping information in this case identifies which of the first, second and third mappings was used to generate the information symbols. If the first mapping is used, that can be used to infer values for q and 1-q, as from that fact it will be known that 0<q<0.4. A value selected from this range, for example q=0.2 can be used for MAP detection. Similarly, q=0.5 might be used for MAP detection with the second mapping, and q=0.8 might be used for MAP detection with the third mapping. Inferring a value of q in this manner eliminates the need to send q as an additional overhead signal.

In another embodiment, the mapping information 32/33 is a value for q. This value for q can then be used to determine which mapping was used, and can also be used for MAP detection.

These examples have been specific to binary information symbols. For M-ary information symbols, M symbol probabilities are needed at the receiver if MAP detection is to be employed. These can be sent as additional overhead. In a preferred embodiment, all of the M symbol probabilities are inferred from the identification of which mapping was employed.

The embodiments have assumed that the mappings take place between information symbols and modulation symbols. More generally, embodiments of the invention provide for mappings between information symbols and transmission symbols. Modulation symbols are one example of a type of transmission symbols which are modulated onto a carrier or carriers. More generally, transmission symbols may or may not be modulated onto a carrier or carriers. An example of transmission symbols which are not modulated to a carrier can be found in new ultra wideband transmission symbols which are transmitted, for example, over a bandwidth spanning 0 Hz (DC) to 10 GHz.

In such embodiments, the modulation symbol processor of FIG. 2B is more generally a transmission symbol processor.

In one embodiment, the adaptive mapping and de-mapping methods described herein are applied in a carrierless transmitter and/or receiver such as an ultra wideband transmitter and an ultra wideband receiver.

The above described embodiments have focussed on mechanisms for switching between different mappings. Of course, it is preferred that each mapping thus selected performs better than the other available mappings for a given input signal, and that mapping selection is carried out such that a switch in mapping is made when a different mapping will perform better than a current mapping. One way of achieving this is to simulate the BER performance of each mapping for an entire range of input signal characteristic, for example for an entire range of non-uniformity, or over a range of interest of non-uniformity. Then, thresholds in signal characteristic/non-uniformity can be identified from the performance results by determining for each signal characteristic value/non-uniformity value which one of the mappings performs best. It is expected that if simulations are run long enough, contiguous ranges of signal characteristic/non-uniformity will result for each mapping.

Constellation Mappings for MAP Decoding

Any mappings can be employed with the above discussed embodiments. Of course, little or no benefit will be achieved if the mappings are not intelligently selected.

In this section, we consider the construction of mappings from a set of nonuniformly distributed symbols to the points of a fixed 2-D constellation with the objective of minimizing SER (symbol error rate) /BER. For a given M-ary constellation, there are M! possible mappings from the source symbol set to the constellation points, and thus, despite the fact that in many cases many of the mappings are equivalent to one another in terms of SER/BER performance (in the case of a binary source), this problem has exponential search complexity.

A further complication is the following: tractable closed-form analytical expressions for the SER or BER under MAP decoding are not known for a general given constellation and a given mapping. Moreover, it is not feasible to search through, for example, thousands of mappings via simulation. To partially address this problem, new upper and lower bounds recently derived in H. Kuai, F. Alajaji, and G. Takahara, “Tight error bounds for nonuniform signaling over AWGN channels,” IEEE Trans. Inform. Theory, vol. 46, pp. 2712-2718, November 2000, are employed to assess the BER/SER performance for any given mapping. The bounds are very accurate and computationally efficient. They are useful for performing exhaustive searches for small values of M(i.e., M≦16 for SER and M≦8 for BER) and for conducting limited searches for moderate values of M(i.e., M=32 for SER and M=16 for BER). In addition, criteria are provided for constructing a heuristic map that performs well compared to optimal maps when known (obtained using our bounds) and locally optimal maps obtained via a search algorithm.

In the case of equally likely signals, the average energy per symbol is the same for all mappings. However, for signals that are not equally likely this is not true, and it is desirable to have mappings which minimize the average energy per symbol. Also, one should minimize the probability of error when the most likely signals are sent. The following criteria, listed in order of priority, are proposed as guidelines for constructing a mapping with the objective of jointly minimizing SER [criteria 1) and 2)] and BER [criterion 3)]:
1) minimize the average energy per symbol for the given symbol probabilities;
2) successively minimize the conditional symbol decoding error probabilities (conditioned on the transmitted symbol), proceeding from the most likely to the least likely symbol;
3) when several mappings all satisfy criteria 1) and 2) equally, choose from these mappings any mapping which is a Gray map or, if not possible, choose a mapping that is closest to a Gray map in the sense of maximizing the number of adjacent pairs of signals that differ in only one bit.
The following condition determines a mapping which satisfies criterion 1) up to permutations within sets of symbols with the same average energy. Given M signals with energies E₁≦ . . . ≦E_{M} and probabilities {ρᵢ}ᵢ₌₁^{M}, and given any permutation π of the energy indices {1, 2, . . . , M}, the sum

$${\sum }_{i = 1}^{M} {E}_{i} {ρ}_{π ( i )}$$

is minimized if and only if the permutation satisfies ρ_{π(1)}≧ . . . ≧ρ_{π(M)}. This condition is valid because if violated (e.g. ρ_{π(i)}>ρ_{π(j)} with i<j) then the average energy can be reduced by interchanging the violating mappings (interchange the mappings of channel signals sᵢ and sⱼ).

Subject to criterion 1), criterion 2) is next considered. Let s₁, . . . , s_{M} denote the signals listed from most likely to least likely. The SER is given by

$$SER = {\sum }_{i = 1}^{M} Pr \{ Symbol Error \vert {s}_{i} sent \} Pr ( {s}_{i} ) .$$

An approach to minimizing the SER is the greedy one [criterion 2)], which consists of first minimizing Pr{Symbol Error|s₁ sent} subject to the average energy per symbol being minimized, then minimizing Pr{Symbol Error|s₂ sent} subject to the average energy per symbol and the first conditional error probability being minimized, etc. At any given stage, after selecting a mapping to minimize the average energy per symbol, a set of permutations of that mapping is available which is more restricted than at the previous stage. From this new restricted set of permutations, a mapping is chosen to minimize the conditional error probability of the current stage.

However, there is a practical limitation to the above procedure: finding the set of maps which minimizes a given conditional error probability [as suggested in criterion 2)] is only slightly less complex than finding the overall optimal map for any moderately sized M. Indeed, this may require considering mapping choices over very large sets.

Therefore, the following two simple heuristics are proposed in accordance with criteria 1)-3) for constellations with several energy levels (such as QAM with M>4) and constellations with a single energy level (such as PSK), respectively.

1) QAM Heuristic Mapping: For each energy level, starting with the lowest and in increasing order of energy levels, choose a set of symbols to fill up that energy level from the set of unallocated symbols to satisfy criterion 1′) below and then allocate the symbols in this chosen set to the signal points of that energy level to satisfy criterion 2′) below.

1′) The symbols in this set are the most likely symbols among the unallocated symbols (note that this set is not unique in general).

2′) The least likely symbols of the current set are the nearest neighbors of the most likely symbols of the set allocated for the previous energy level.

When there is more than one set/allocation of symbols that satisfies criteria 1′) and 2′), use a Gray mapping procedure [as discussed in 3) above] to identify a single set and allocation.

2) PSK Heuristic Mapping: For constellations with a single energy level (such as PSK), the following simpler heuristic is proposed.

1) Place the (single) most likely symbol arbitrarily.

2) Place the next m=log₂ M most likely symbols such that these first m+1 most likely symbols are as uniformly spread as possible, with the most likely symbol being the most isolated (in Euclidean distance sense) when possible.

3) Place the two least likely symbols next to the most likely symbol and the next 2 m least likely symbols as nearest neighbors to the m symbols placed in step 2), adhering to the Gray mapping principle whenever possible.

4) Repeat steps 2) and 3) until all the remaining symbols are placed.

3) Search Algorithm: Criteria 1′)-2′) [or 1)-4)] can be implemented in-the following algorithm to search for locally optimal mappings that have good SER and BER performance.
Set n=1, E_{b}/N₀=lowest SNR of interest, and Δ=increment.
Use criteria 1′)-2′) [or 1)-4)] to determine a mapping M₁.
While E_{b}/N₀<highest SNR of interest, do the following:

Input mapping Mₙ as the initial point in a steepest descent search algorithm, which searches locally at each iteration for the mapping which minimizes the objective function (SER or BER) by interchanging the assignment of a pair of symbols. Let Mₙ₊₁ denote the final (locally optimal) mapping obtained by this search.
Let n=n+1 and E_{b}/N₀=E_{b}/N₀+Δ.
Note that the mapping provided by the above search algorithm is, in general, a function of E_{b}/N₀.

### EXAMPLE PERFORMANCE RESULTS

Performance results were obtained using a simulator which simulated MAP decoding for a Gray map and for the M₁ and M₁′ map. This program took a q (the percentage of bits being a zero) and computed the bit and symbol error rates. The simulation used additive white Gaussian noise for various signal to noise ratios. All of the results are for 64 QAM.

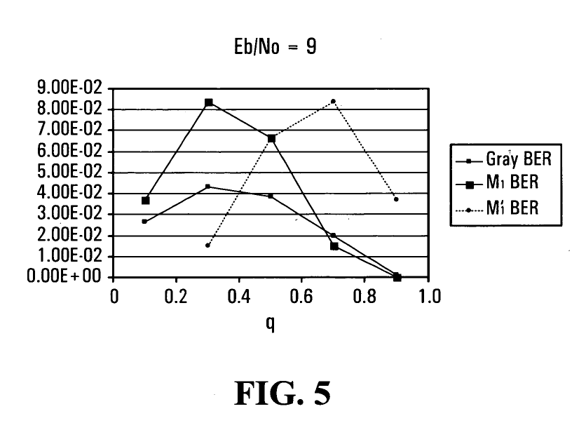

In order to determine thresholds, simulation was conducted at a particular E_{b}/N₀ (=9) over the range of q. Results are shown in FIG. 5 for the Gray mapping, M₁ mapping and M₁′ mapping. It can be seen that for q<about 0.4, the M₁′ mapping performs the best. For q>about 0.65, the M₁ mapping performs best. For q between 0.4 and 0.65, the Gray mapping performs best. The q value 0.4 can be used as an M₁′ threshold, and the q value 0.65 can be used as an M₁ threshold. The results of these simulations agree with what was expected. The M₁ mapping was created to give improved performance for high values of q. The M₁′ mapping was created by inverting all the bits of the M₁ mapping (0's became 1's and vice versa), thus improving performance for low q values. The Gray mapping is optimized for q=0.5.

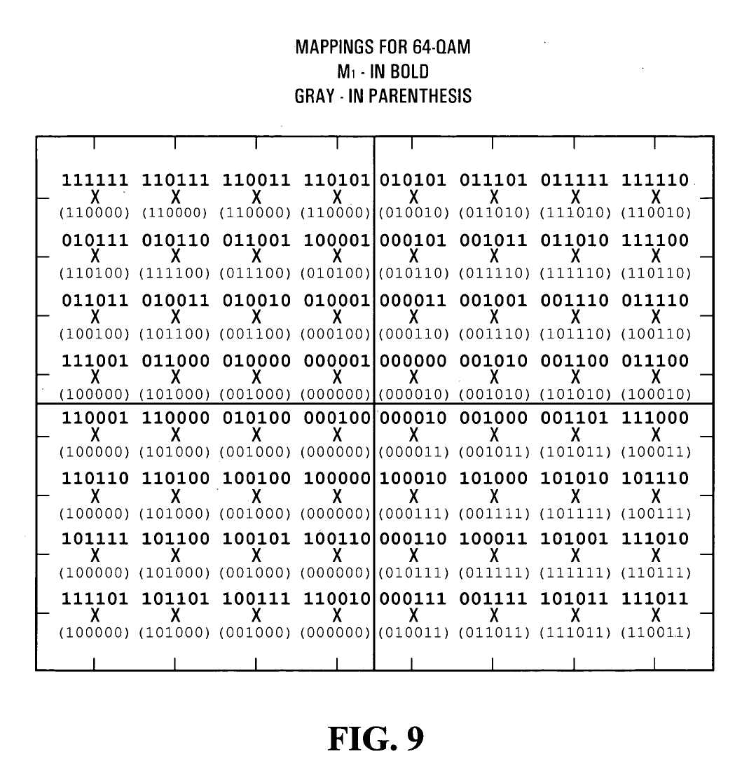

FIG. 9 shows an example of the M₁ mapping for 64 QAM with the Gray mapping also shown in parentheses.

The simulator opens a specified binary file and reads the first N=3000 bits. As the 3000 bits are read the program counts the number of zero's and computes q for the 3000-bit sample. This 3000-bit sample is then simulated in the same fashion as before.

To assess the adaptive mapping approach, the program takes input from a file and based on the value of q for each 3000 bit sequence it selects a different mapping to use. If the q value is less than the M₁′ threshold (set at 0.4) the M₁′ mapping is used. If the q value is greater than the M₁ threshold (set at 0.65) the M₁ mapping is used and if the q value is between the two thresholds the gray mapping is used. Simulation was done with real multimedia files. A range of file types were used, and included the following files:
Abyss.wav (compressed audio file)
Ccitt1.pgm (fax document)
Cprfd10.txt (David Copperfield novel)
Crsto10.txt (Count of Monte Cristo novel)
Eiffel.jpg (photograph of Eiffel tower)
Kitty.avi (television commercial)
Similar Promises.mp3 (audio file)
Skeleton.avi (computer generated video)
Triggerman.mp3 (audio file)
Headscan.pgm (medical image file)

It is important to notice that many of these popular media types are compressed formats.

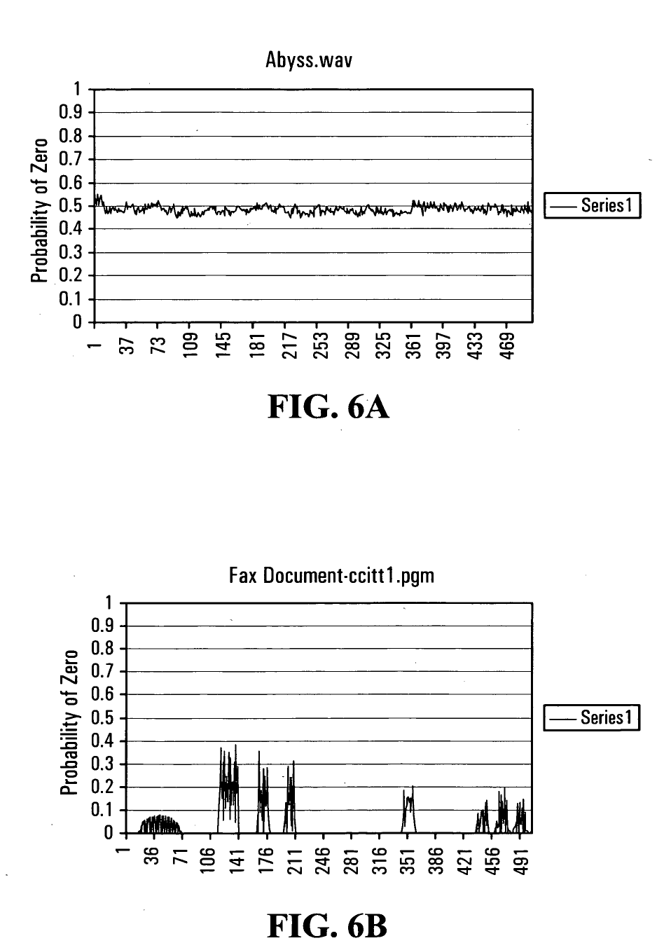

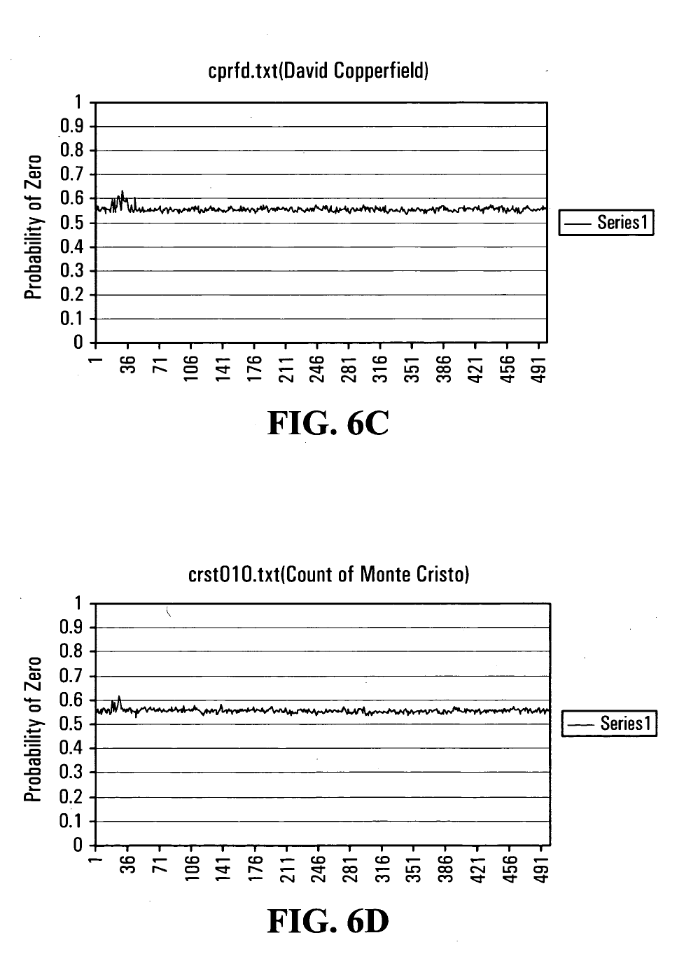

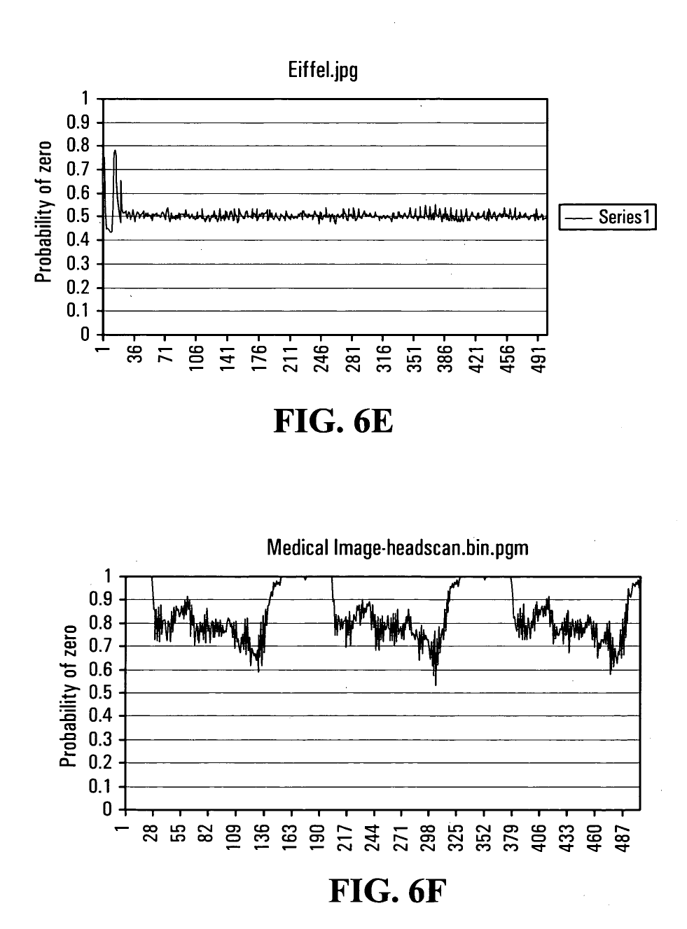

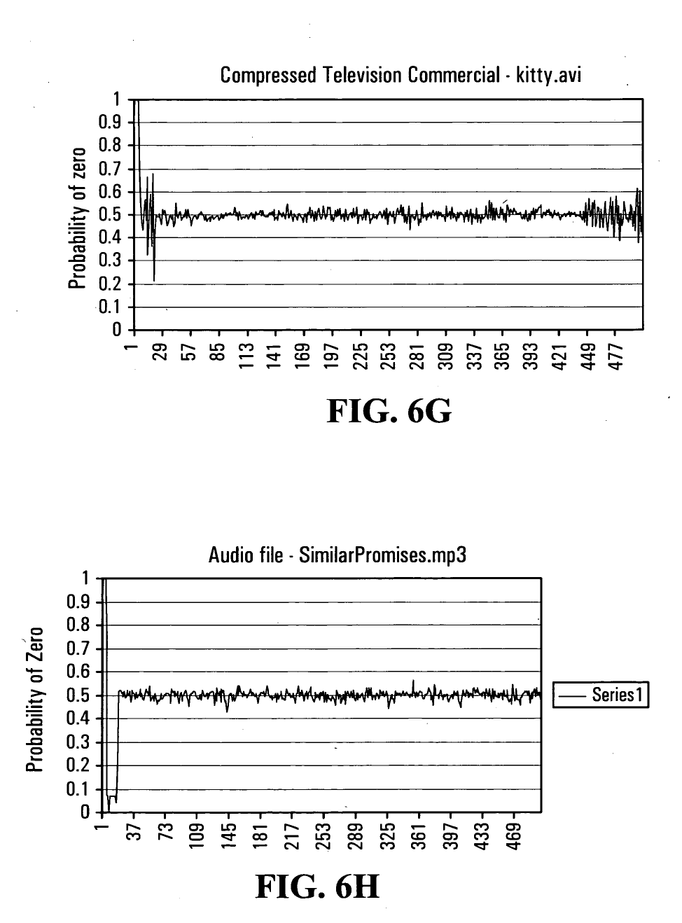

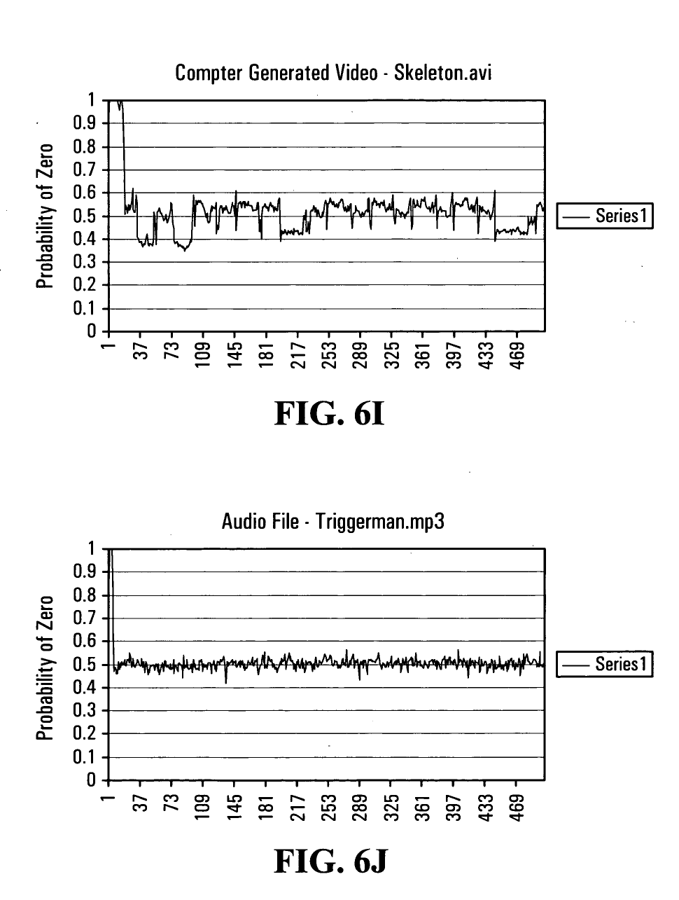

The distributions of some of aforementioned files were analyzed and the results are plotted in FIGS. 6A through 6J. The graphs show the proportion of zeros in the file. The files were divided into bins of 3000 bits. The x axis shows the bin number, and the y axis shows the proportion of zero bits in the corresponding 3000 bit segment. All files except the fax documents, and the medical image file, had nearly uniform distributions. The files did have traces of non-uniformity, particularly at the start of the files, which is assumed to be types of control code in the header of the files. The uniform distribution of the files is expected, since the compression applied removes the non-uniformity present.

The fax documents and the medical file both had non-uniform distributions. The fax documents had low proportions of zeros. Every bin had a proportion less than 0.4, and many consecutive bins had no zeros.

The medical image document shows a distribution with a high proportion of zeros. This file was originally too small for the desired simulations. In order to make it large enough, the data in the file was copied and appended to the file three times. This accounts for the similarities within the file (the two identical bumps). The proportion stays for the most part above 0.6 (with the exception of bin 305 having a proportion of 0.5333).

Simulation with the Gray Mapping, the M₁ mapping, and the M₁′ mapping was then done with the multimedia files. For simplicity, only three files were analyzed. All compressed file types exhibited nearly identical behaviour, so the Kitty.avi file was analyzed from that collection of files. Both fax documents also had nearly identical behaviour, so the ccitt1.pgm was analyzed. As no other document had a distribution like the medical image, that file was also analyzed.

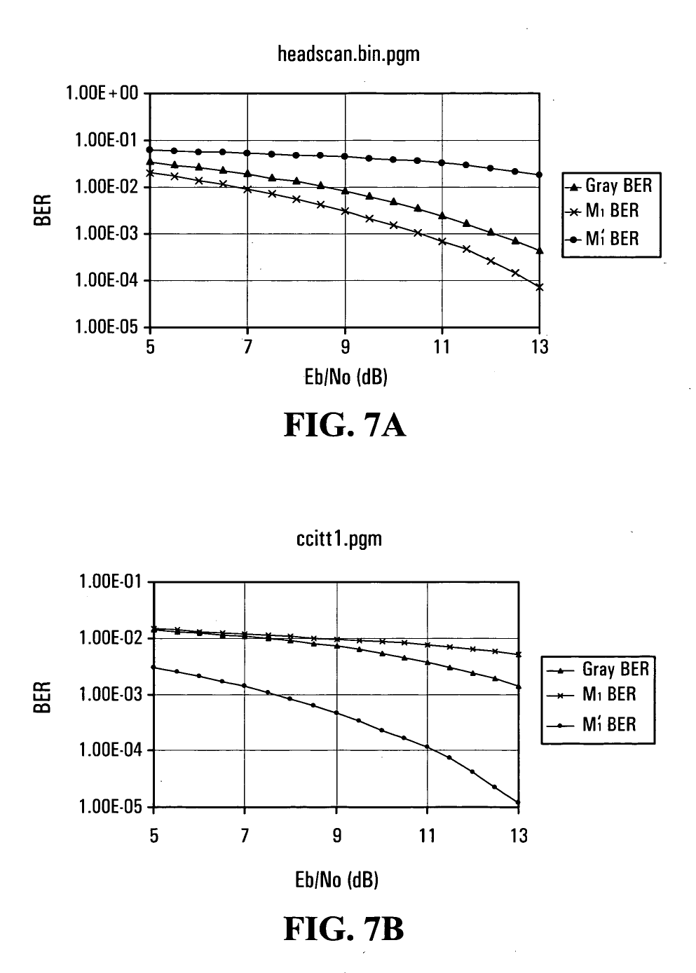

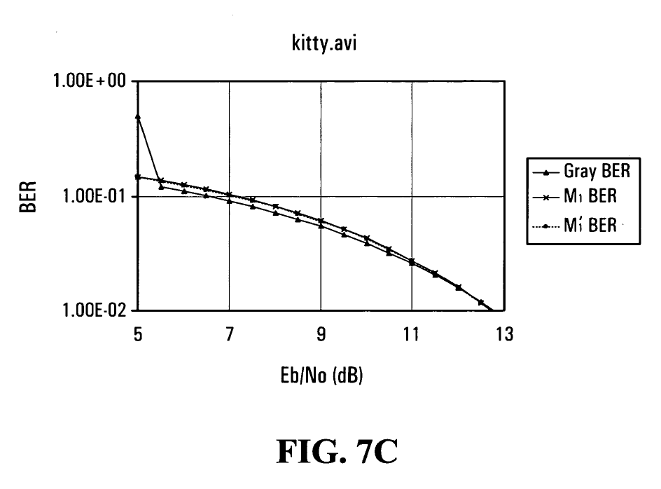

The plot for the headscan.pgm file appears in FIG. 7A. It shows the M₁ mapping having the lowest BER, followed by the Gray mapping. The M₁′ mapping had the worst BER performance. These results agreed with expectations and with the results from the previous work with the randomly generated sequences. The M₁ map yielded superior BER performance with high values of q. The headscan file had a distribution with a high proportion of zeros, thus the M₁ map gave the lowest BER. The M₁′ mapping gave superior performance for data with low values of q.

The plot for the fax document appear in FIG. 7B. Since the fax documents had distributions with low proportion of zeros, the M₁′ mapping gave the lowest BER. It should noted that if M₁ yielded the lowest BER, the M₁′ map yielded the highest BER, and vice versa. This was also expected, since a mapping optimized for high zero content should not lower BER for low zero content data in the MAP decoding scheme.

The performance for the file kitty.avi, one of the compressed files is shown in FIG. 7C. The comparison of the three mappings gave similar BER results. The Gray mapping just barely beat the other two mappings with a difference in signal to noise ratio of less than 0.5 dB. The closeness in the three mappings may be attributed in some part to the header non-uniformity of the file, but mostly to the response of MAP decoding to the uncertainty of the data (P(X=0)=P(X=1)=½).

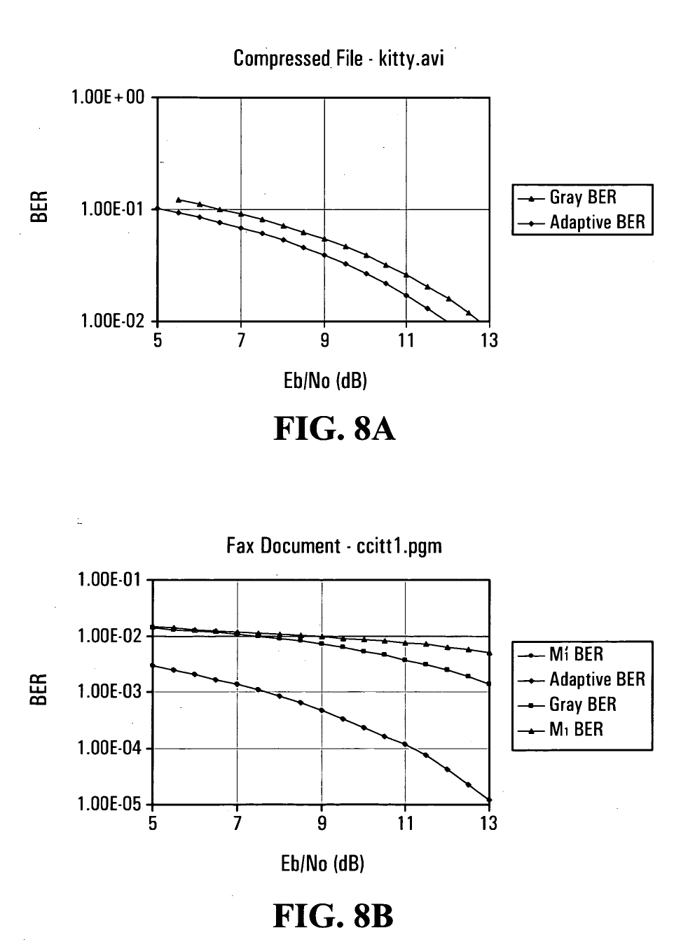

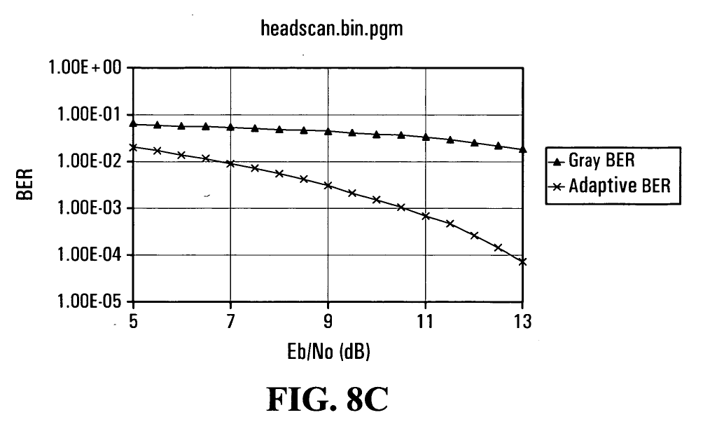

The adaptive mapping strategy was then tested against the other available mappings using the specific thresholds identified above. Again for simplicity, the same three files will be used for analysis. The kitty.avi file was the first file simulated. The results are shown in FIG. 8A. The adaptive mapping gave a lower BER than the Gray mapping (and also the M₁ and M₁′). The curve for the adaptive mapping is generally about 1 dB to the left of the curve for the Gray mapping. For example, it can be seen that for a target BER of 1.00×10⁻², the adaptive mapping requires about 11.8 dB, while the Gray mapping requires about 12.8 dB, so the adaptive mapping represents about a 1 dB savings.

The ccitt1.pgm was simulated and the results are shown in FIG. 8B. Both the M₁′ mapping and the adaptive mapping gave identical low BER results. The distribution of the ccitt1 file shows that the proportion of zeros never rises above 0.4, so no mapping besides the M₁′ mapping was used. All these results agreed with what was expected. It can be seen that to achieve a target BER of 1.00×10⁻³, the adaptive mapping requires about 7.5 dB, while the Gray mapping requires about 13.5 dB, so the adaptive mapping represents about a 6 dB savings.

The next file simulated was the headscan.pgm file. The adaptive mapping and the M₁′ mapping (not shown) yielded identical results, both having BER lower than the Gray mapping and the M₁ mapping. This would seem suspicious, but recall that the switching bounds for the adaptive mapping were set at 0.4 on the low end and 0.65 on the high end. The distribution of the headscan file shows that the proportion of zeros only rarely falls below 0.6. Thus, the M₁′ mapping was used for most of the simulation.

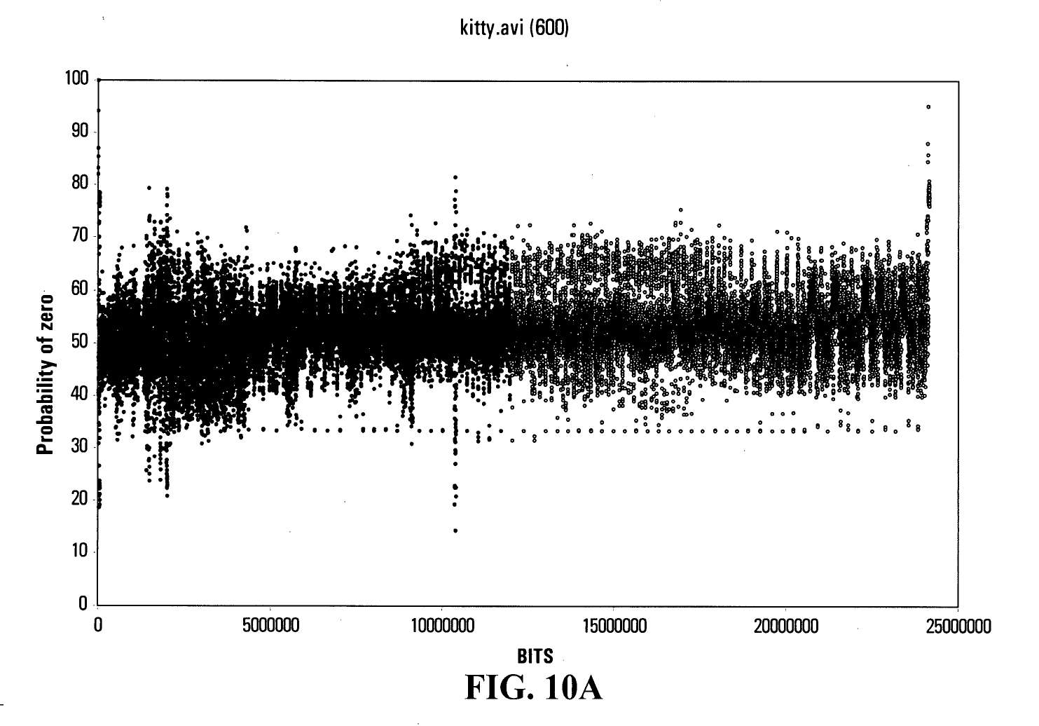

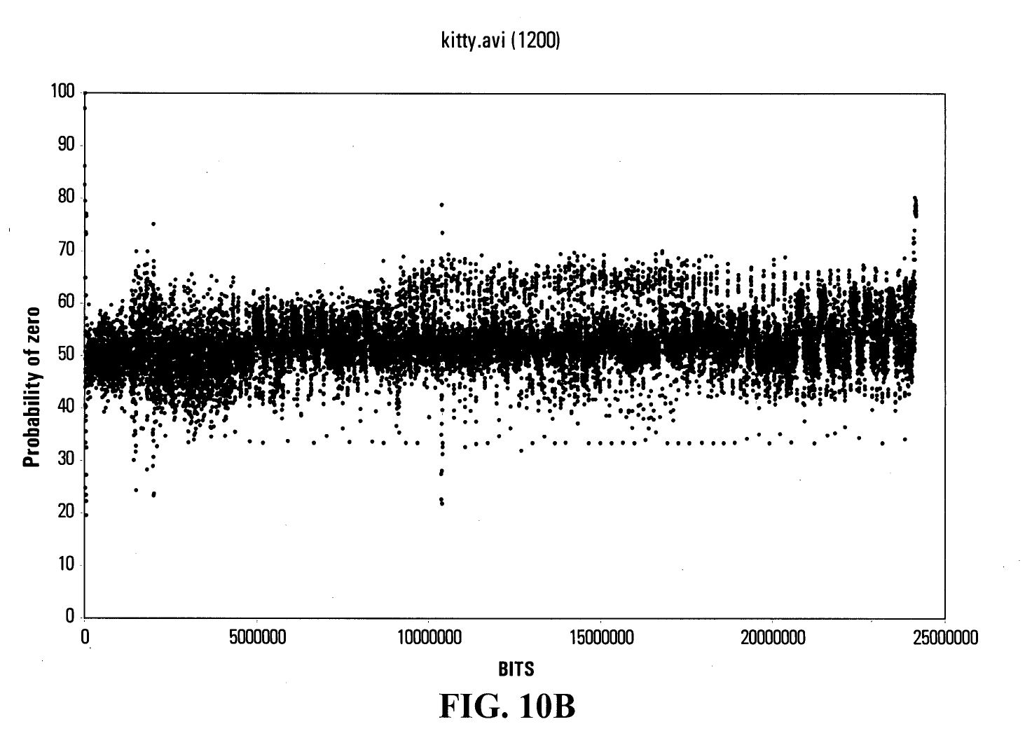

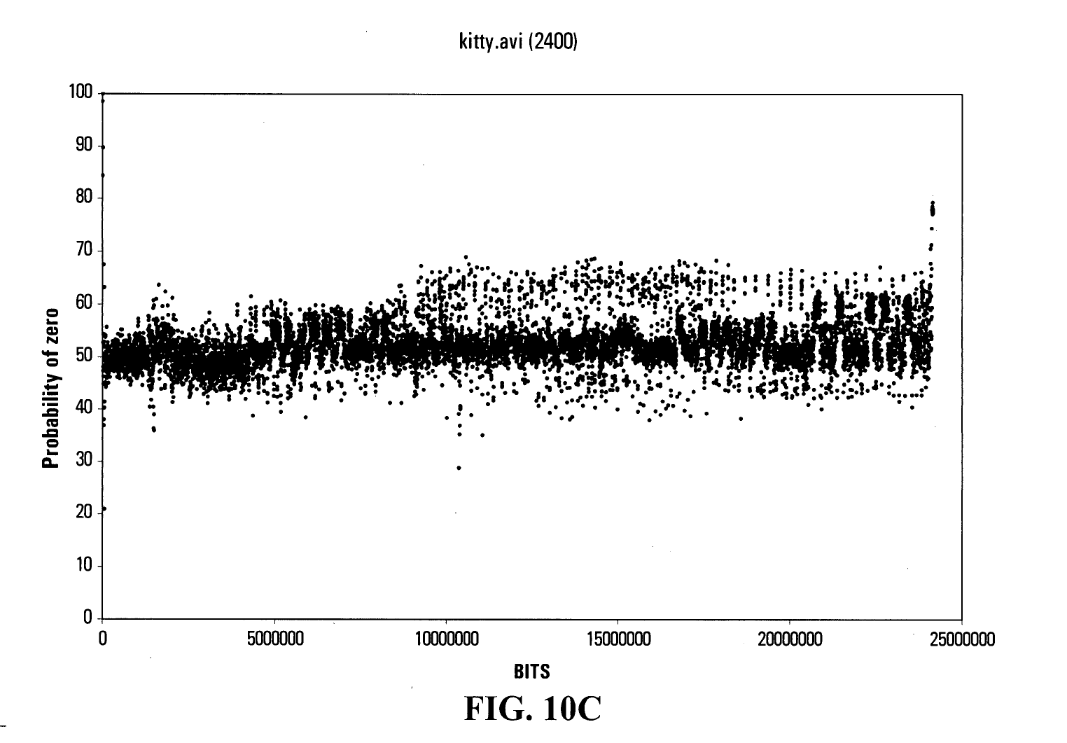

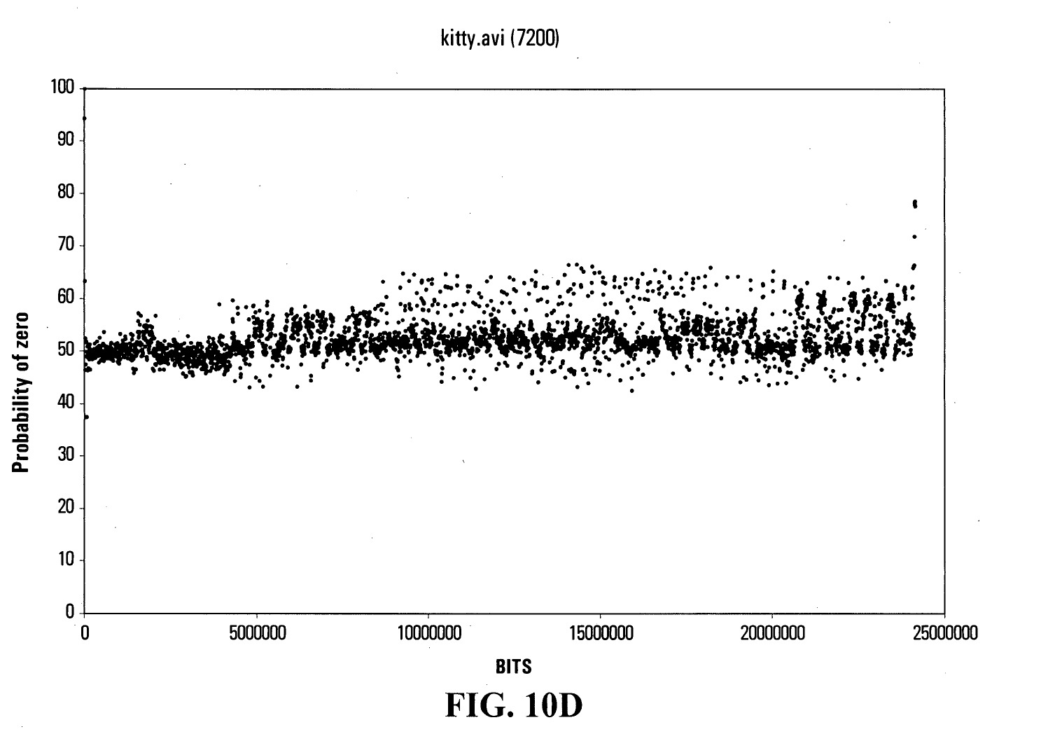

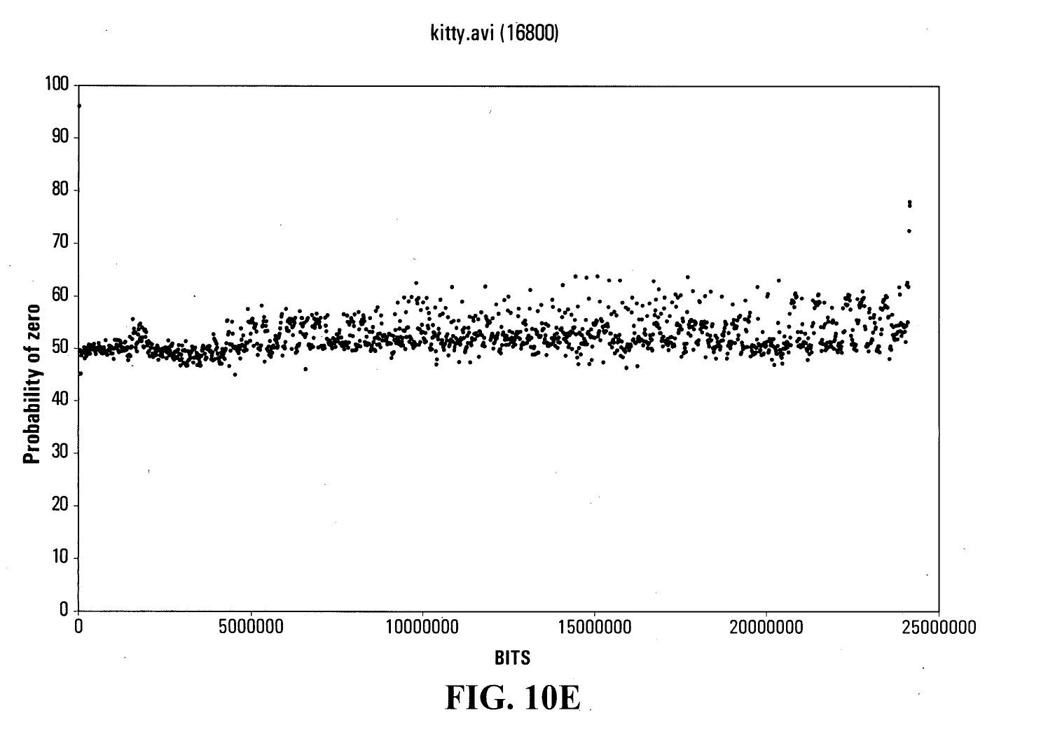

FIGS. 10A through 10E are plots of signal uniformity for the same data file considered earlier in FIG. 6G for block sizes of 600, 1200, 2400, 7200, 16800 respectively over which non-uniformity is measured. It can be seen that the data non-uniformity increases as block size decreases. This translates into improved performance of the M₁ mapping as the block size decreases.

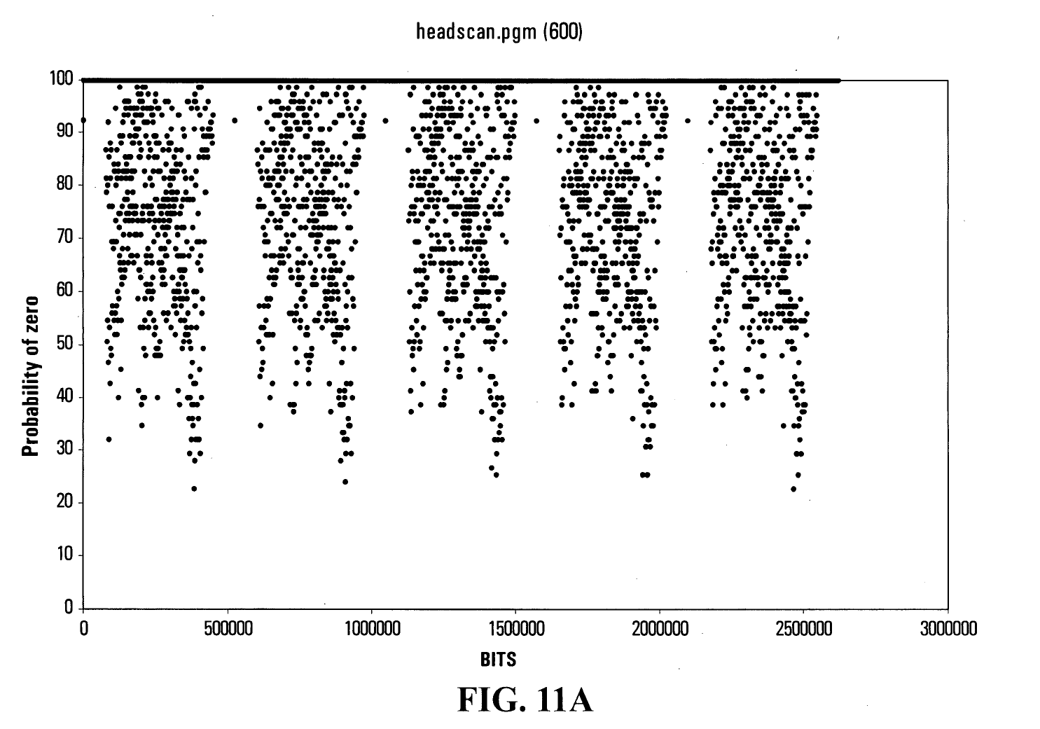

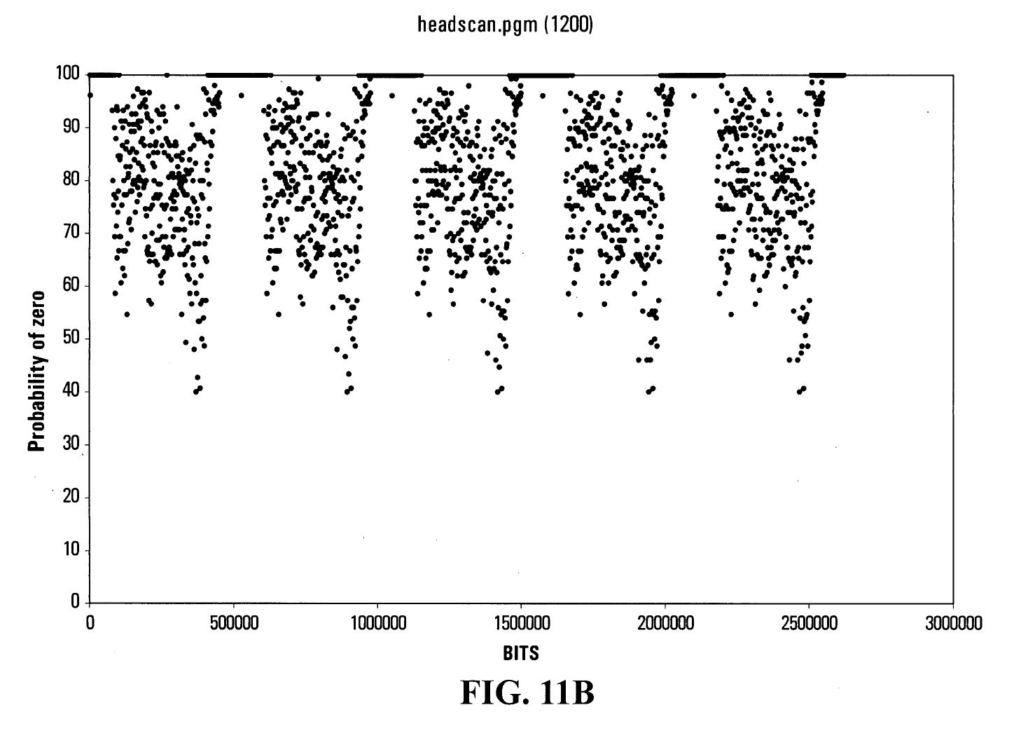

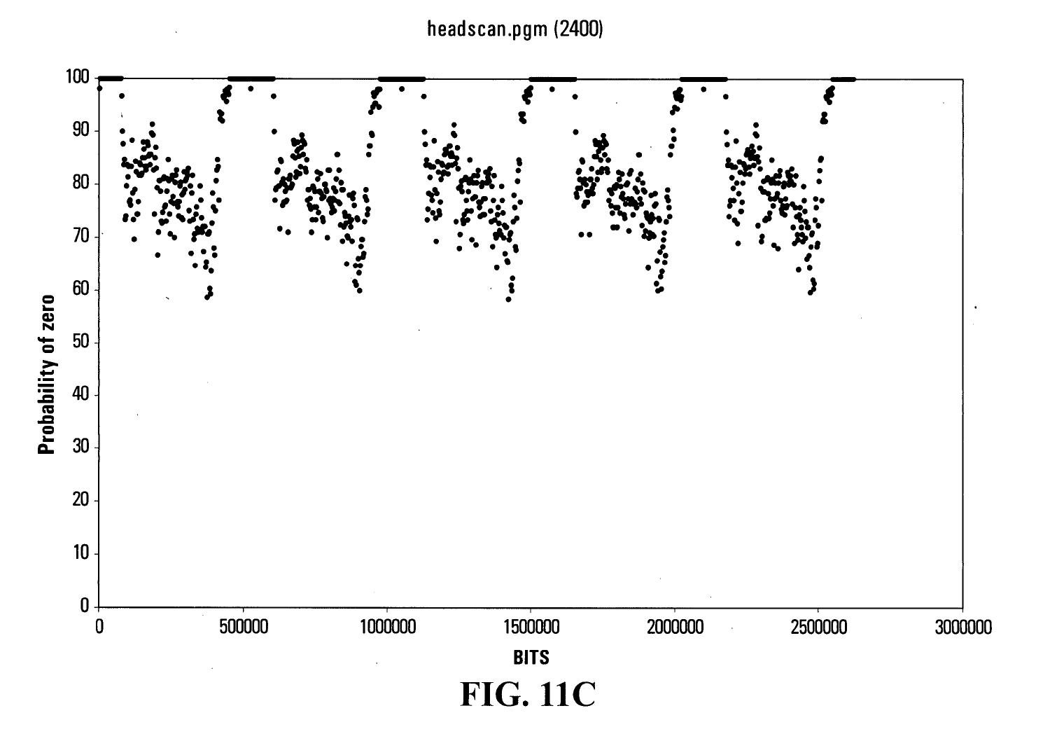

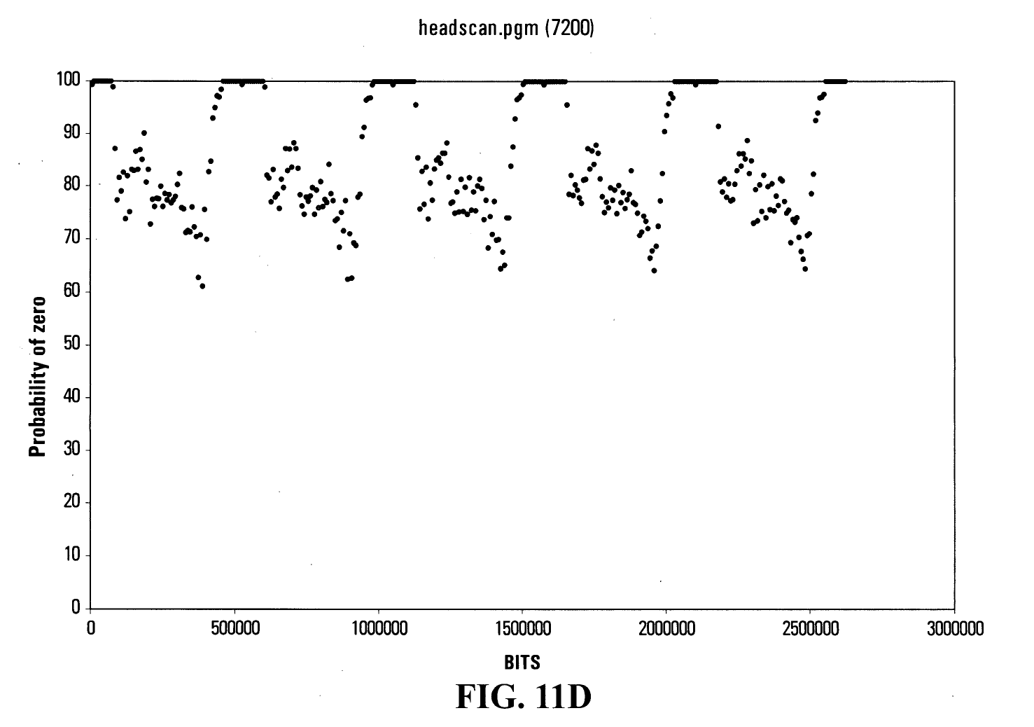

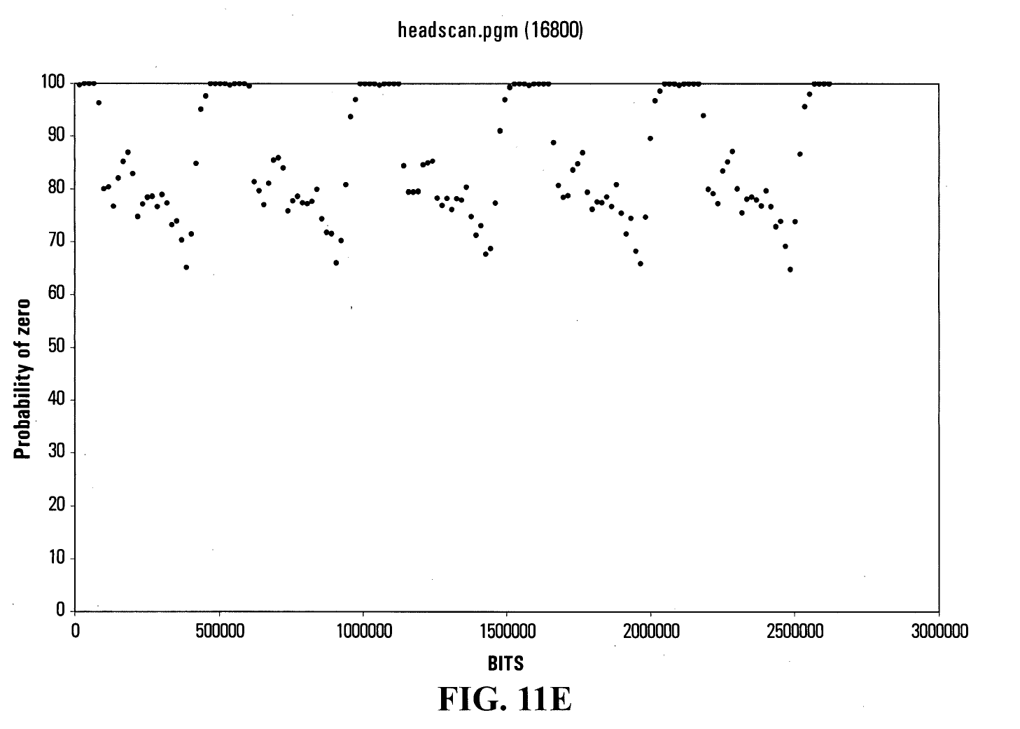

FIGS. 11A through 11E are plots of signal uniformity for the same data file considered earlier in FIG. 6F for block sizes of 600, 1200, 2400, 7200, 16800 respectively over which non-uniformity is measured. It can again be seen that the data non-uniformity increases as block size decreases. This translates into improved performance of the M₁ mapping as the block size decreases.

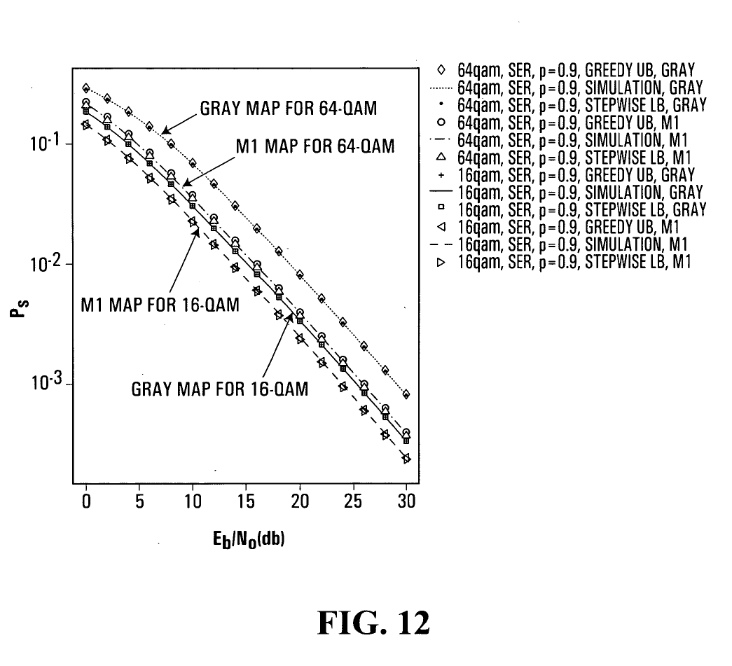

The above examples assume an additive white Gaussian noise channel. The M₁ mapping also performs well in a Rayleigh fading channel. An example of this is shown in FIG. 12 which is a plot of symbol error rate Pₛ for 16, 64-QAM with Gray mapping and M₁ mapping in a Rayleigh fading channel. Both simulation results and Greedy upper bounds are presented.

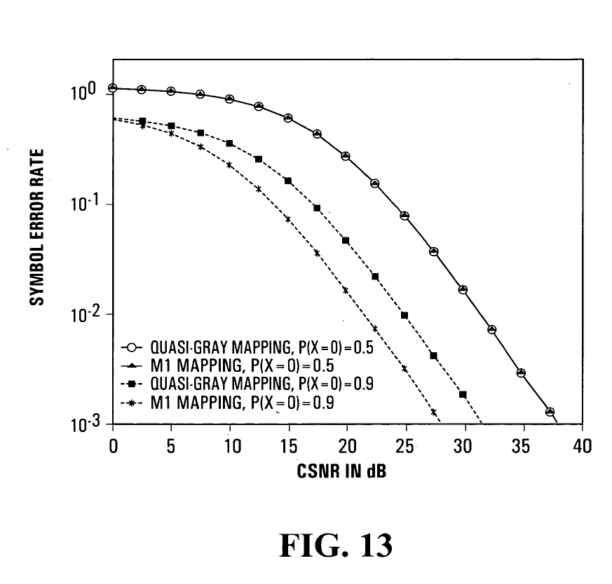

The above examples have assumed a single transmit antenna and a single receive antenna. The M₁ mapping also performs well in a MIMO (multiple input multiple output environment. An example of this is shown in FIG. 13 which is a comparison plot showing the symbol error rate performance as a function of channel signal-to-noise ratio (CSNR) of the Gray and M₁ mappings with 64-QAM for a system with K=2 transmit antennas, L=1 receive antenna, using the G² STOB code defined in S. M. Alamouti, “A simple transmitter diversity scheme for wireless communications,” IEEE J. Select. Areas Commun., vol. 16, pp. 1451-1458, October 1998.

Numerous modifications and variations of the present invention are possible in light of the above teachings. It is therefore to be understood that within the scope of the appended claims, the invention may be practiced otherwise than as specifically described herein.

1. A method comprising:
determining mapping selection information in respect of a set of information symbols;
selecting a selected mapping from a plurality of mappings for a signal constellation as a function of the mapping selection information;
mapping the set of information symbols to the signal constellation using the selected mapping to produce transmission symbols.

2. A method according to claim 1 wherein the transmission symbols comprise modulation symbols.

3. A method according to claim 1 further comprising:
dividing an information symbol stream into a plurality of sets of information symbols;
performing the steps of determining, selecting and mapping for each set of said plurality of sets.

4. A method according to claim 3 further comprising:
for each set of information symbols, transmitting mapping information allowing an identification of the selected mapping for the set of information symbols.

5. A method according to claim 4 wherein the mapping information comprises an identifier for the selected mapping.

6. A method according to claim 1 wherein determining mapping selection information comprises determining a measure of entropy in respect of the set of information symbols.

7. A method according to claim 1 wherein determining mapping selection information comprises determining a measure of non-uniformity within the set of information symbols.

8. A method according to claim 7 further comprising transmitting non-uniformity information in respect of the set of information symbols from which the selected mapping can be derived.

9. A method according to claim 7 wherein the information symbols comprise bits, and wherein the measure of non-uniformity is determined by determining how many bits in the set of information symbols are ones and how many bits in the set of information symbols are zeros.

10. A method according to claim 1 wherein determining mapping selection information comprises determining a measure of memory in the set of information symbols.

11. A method according to claim 1 wherein determining mapping selection information comprises determining a measure of memory and non-uniformity a set of information symbols.

12. A method according to claim 1 further comprising transmitting the transmission symbols.

13. A method according to claim 12 wherein the transmission symbols comprise carrierless transmission symbols.

14. A method according to claim 2 further comprising transmitting the modulation symbols.

15. A method according to claim 14 wherein transmitting the modulation symbols comprises transmitting the modulation symbols on a wireless channel.

16. A method according to claim 1 wherein one of said plurality of mappings is a Gray mapping, and at least one of the plurality of mappings is an Mₙ mapping.

17. A method according to claim 1 wherein said plurality of mappings comprises a first mapping which is a Gray mapping, a second mapping which is an Mₙ mapping, and a third mapping which is an inverse of the Mₙ mapping.

18. A method according to claim 17 wherein the first mapping is employed for a first range of non-uniformity in the set of information symbols, the second mapping is employed for a second range of non-uniformity in the set of information symbols, and the third mapping is employed for a third range of non-uniformity in the set of information symbols.

19. A method according to claim 1 wherein each of said plurality of mappings provides enhanced BER (bit error rate) performance over a communications channel of interest for a respective range of measure of entropy.

20. A method according to claim 1 wherein the plurality of mappings comprise a respective mapping for each of a plurality of ranges of non-uniformity.

21. A method according to claim 12 further comprising:
remotely receiving the transmission symbols;
processing the transmission symbols using knowledge of the selected mapping.

22. A method according to claim 21 wherein the transmission symbols comprise modulation symbols.

23. A method according to claim 22 wherein the modulation symbols are processed using a MAP (maximum a posteriori) detector.

24. A method according to claim 21 further comprising determining the selected mapping using blind detection.

25. A method according to claim 4 further comprising:
remotely receiving the transmission symbols;
remotely receiving the mapping information;
determining the selected mapping from the mapping information;
processing the transmission symbols using the selected mapping.

26. A method according to claim 25 wherein the mapping information identifies the selected mapping, the method further comprising:
inferring a signal non-uniformity from the mapping information;
performing MAP detection using the signal non-uniformity.

27. A method according to claim 25 wherein the mapping information identifies a signal non-uniformity, the method further comprising:
remotely determining the selected mapping from the signal non-uniformity;
performing MAP detection using the signal non-uniformity.

28. A modem adapted to implement a method according to claim 1.

29. A transmitter adapted to implement a method according to claim 1.

30. A computer readable medium having instructions stored thereon for execution on a processing platform so as to implement a method according to claim 1.

31. A mapping system for mapping a set of information symbols to a transmission symbols of a signal constellation, the mapping system comprising:
a mapper input stream analyzer adapted to analyze the set of information symbols and determine a selected mapping from a plurality of mappings for the signal constellation;
a mapper adapted to map the set of information symbols to the signal constellation using the selected mapping to produce transmission symbols.

32. A modem comprising the mapping system of claim 31.

33. A transmitter comprising the mapping system of claim 31, the transmitter being adapted to transmit the transmission symbols.

34. A mapping system according to claim 31 further adapted to divide an information symbol stream into a plurality of sets of information symbols;
wherein the mapper input stream analyzer and the mapper analyze each set and select a mapping for each set.

35. A mapping system according to claim 31 further adapted to, for each set of information symbols, transmit mapping information allowing an identification of the selected mapping for the set of information symbols.

36. A mapper according to claim 32 wherein the mapper determines at least one of symbol non-uniformity, entropy, redundancy, memory in determining the selected mapping.

37. A de-mapper comprising:
an input for receiving a set of transmission symbols which were mapped from a set of information symbols using a selected mapping of a plurality of mappings for a signal constellation;
a transmission symbol processor adapted to process the transmission symbols using knowledge of the selected mapping.

38. A de-mapper according to claim 37 adapted to obtain knowledge of the selected mapping using blind detection.

39. A de-mapper according to claim 37 further adapted to receive mapping information allowing an identification of the selected mapping.

40. A de-mapper according to claim 39 wherein the mapping information identifies the selected mapping, the de-mapper being further adapted to infer a signal non-uniformity from the mapping information, and to perform MAP detection using the signal non-uniformity.

41. A de-mapper according to claim 39 wherein the mapping information identifies a signal non-uniformity, the de-mapper being further adapted to determine the selected mapping from the signal non-uniformity, and perform MAP detection using the signal non-uniformity.

42. A system comprising a transmitter and a receiver, the transmitter comprising:
a mapping system for mapping a set of information symbols to a transmission symbols of a signal constellation, the mapping system comprising:
a mapper input stream analyzer adapted to analyze the set of information symbols and determine a selected mapping from a plurality of mappings for the signal constellation;
a mapper adapted to map the set of information symbols to the signal constellation using the selected mapping to produce transmission symbols for transmission by the transmitter;
the receiver comprising:
an input for receiving a set of transmission symbols which were mapped from a set of information symbols using a selected mapping of a plurality of mappings for a signal constellation; and
a transmission symbol processor adapted to process the transmission symbols using knowledge of the selected mapping.

43. A system according to claim 42 wherein the transmitter is further adapted to:
divide an information symbol stream into a plurality of sets of information symbols, and to analyze each set and select a mapping for each set;
for each set of information symbols, transmit mapping information allowing an identification of the selected mapping for the set of information symbols;
wherein the receiver is adapted to receive the mapping information allowing an identification of the selected mapping for each set of information symbols.
